(19) United States
(12) Patent Application Publication
(10) Pub. No.: US 2003/0172024 A1
(43) Pub. Date: Sep. 11, 2003

(54) Trade profiler

(76) Inventors: Christopher Kokis, Monroe, CT (US); Robert A. Waghorne, FairField, CT (US); Peter J. Martyn, Ridgewood, NJ (US); Natalya Okunev, Brooklyn, NY (US)

Correspondence Address: DENIS G. MALONEY, Fish & Richardson P.C., 225 Franklin Street, Boston, MA, 02110-2804, US

(21) Appl. No.: 10/295,011

(22) Filed: Nov. 14, 2002

Related U.S. Application Data
(60) Provisional application No. 60/335,388, filed on Nov. 14, 2001.
(60) Provisional application No. 60/385,979, filed on Jun. 5, 2002.
(60) Provisional application No. 60/385,988, filed on Jun. 5, 2002.

(51) Int. Cl. G06F 17/60

(52) U.S. Cl. 705/37

(57) ABSTRACT

A market participant profiling process includes a parameter specification process that allows a market participant to define one or more default order processing parameters. A default parameter application process applies the default order processing parameters to all future orders entered by the market participant.

### RELATED APPLICATIONS

This application claims the priority of: U.S. Provisional Patent Application No. 60/335,388, entitled “Super Montage”, and filed on Nov. 14, 2001; U.S. Provisional Patent Application No. 60/385,979, entitled “Supermontage Architecture”, and filed on Jun. 5, 2002; and U.S. Provisional Patent Application No. 60/385,988, entitled “Security Processor”, and filed on Jun. 5, 2002.

### BACKGROUND

This invention relates to electronic securities trading, and the processing and displaying of information relating to electronic securities trading.

Electronic equity markets, such as The Nasdaq Stock Market™ collect, aggregate, and display pre-trade information to market participants. In the Nasdaq Stock Market, for example, this pre-trade information takes the form of a quote that represents a single or an aggregate of same-priced principal or agency orders. A market, such as The Nasdaq Stock Market™, also provides trading platforms through which market participants may trade securities in the marketplace.

### SUMMARY

According to an aspect of this invention, a market participant profiling process includes a parameter specification process that allows a market participant to define one or more default order processing parameters. A default parameter application process applies the default order processing parameters to all future orders entered by the market participant.

One or more of the following features may also be included. The parameter specification process is configured to allow the market participant to modify a previously defined set of default order processing parameters. The default parameter application process is configured to allow the market participant to overwrite at least one default order processing parameter for a single order entered by the market participant.

The default order processing parameter is a priority processing parameter that specifies the sequence in which incoming orders entered by the market participant are processed. Other default order processing parameters can be a clearinghouse parameter that specifies the clearinghouse that will process the order entered by the market participant, a capacity parameter that specifies the capacity in which the market participant who placed the order is acting and/or an AIQ parameter that prevents the market participant who entered the order from trading with itself. The default order processing parameter can also be a duration parameter that specifies the duration of the order entered by the market participant, a verification threshold, which requires that orders involving a greater number of shares than the verification threshold require verification of the order by the market participant prior to the order being processed.

The above-described processes may also be implemented as a method or a sequence of instructions executed by a processor.

One or more advantages can be provided from the above. The market participant can quickly define default order processing parameters for common order-entry fields. By defining these parameters ahead of time, order entries can be made more efficient. Further, by allowing the market participant to override individual default order processing parameters, orders that vary slightly from the typical order entered by the market participant can be quickly modified and entered.

### DESCRIPTION OF DRAWINGS

FIG. 1 is a block diagram of a computerized trading system including a market participant profiling process and an order execution process;

FIG. 2 is a block diagram of an order execution process;

FIG. 3 is a diagrammatic view of a summarized display;

FIG. 4 is a block diagram of a market participant profiling process;

FIG. 5 is a diagrammatic view of an order entry window; and

FIG. 6 is a block diagram of a market participant profiling method.

### DETAILED DESCRIPTION

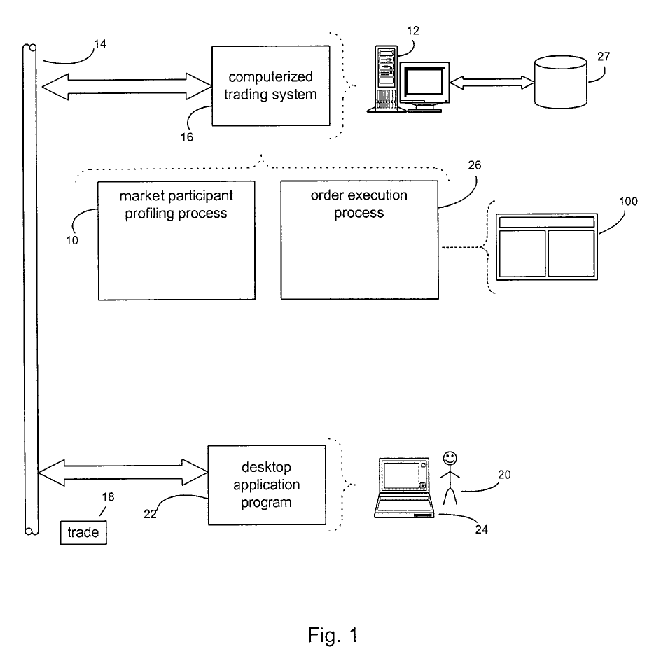

Referring to FIG. 1, there is shown a market participant profiler process 10. Market participant profiler process 10 resides on a server 12 that is connected to a distributed computing network 14 (e.g., the Internet, an intranet, a local area network, or some other form of network). Computerized trading system 16, which trades securities electronically and also resides on server 12, processes attributable security interest messages 18. These messages, which are entered by market participants (e.g., market participant 20), concern a specific security sought for purchase or offered for sale on computerized trading system 16. Market participant 20 typically accesses and uses computerized trading system 16 via a desktop application 22 (e.g., Microsoft Internet Explorer™, Netscape Navigator™, the Nasdaq Workstation II™, a specialized desktop interface, etc.) residing on a computer 24, thus allowing market participant 20 to trade securities with other market participants (not shown).

Market participant profiler process 10 allows market participant 20 to define default order processing parameters (not shown) that are useable by order execution process 26. Prior to discussing market participant profiling process 10, order execution process 26 will be discussed.

Order execution process 26 allows market participant 20 to monitor the trading activity for a specific security that is traded on computerized trading system 16 (within a specified price range), and place orders concerning that security. Process 26 provides market participant 20 with a summarized display 100 (to be discussed below in greater detail) concerning this security, which is viewable on computer 24. Typically, summarized display 100 is one screen in size, thus allowing market participant 20 to quickly get an overview of the activity of the specific security without having to scroll through or toggle between multiple screens. Through summarized display 100, market participant 20 can execute orders for the security that is summarized in display 100.

Execution process 26 typically resides on a storage device 27 connected to server 12. Storage device 27 can be a hard disk drive, a tape drive, an optical drive, a RAID array, a random access memory (RAM), or a read-only memory (ROM), for example. Additionally, computerized trading system 16 stores all information relating to securities trades on storage device 27.

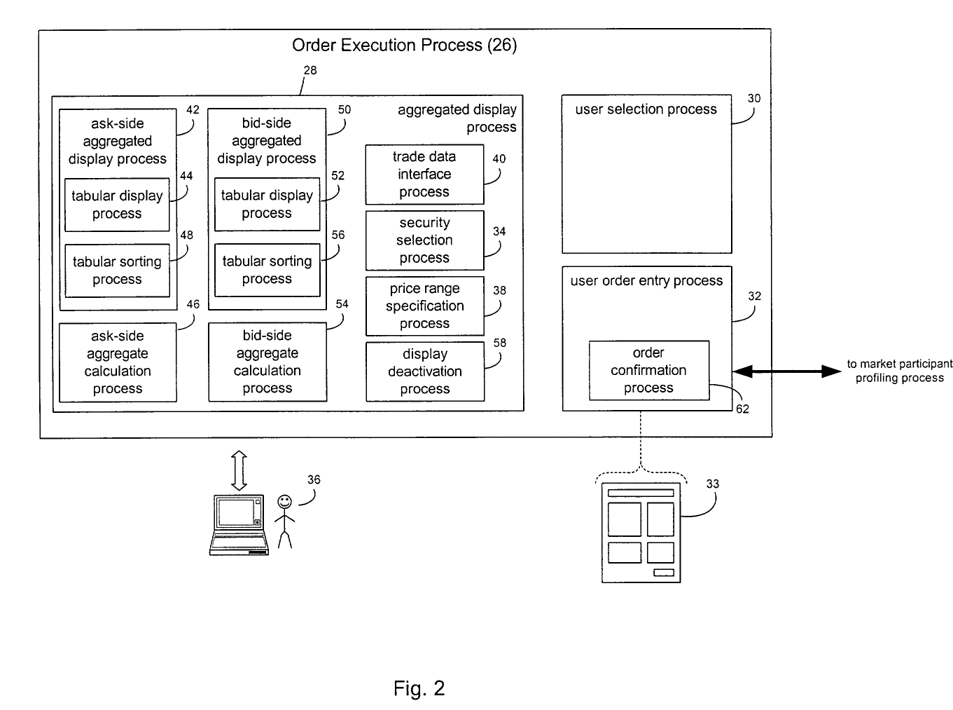

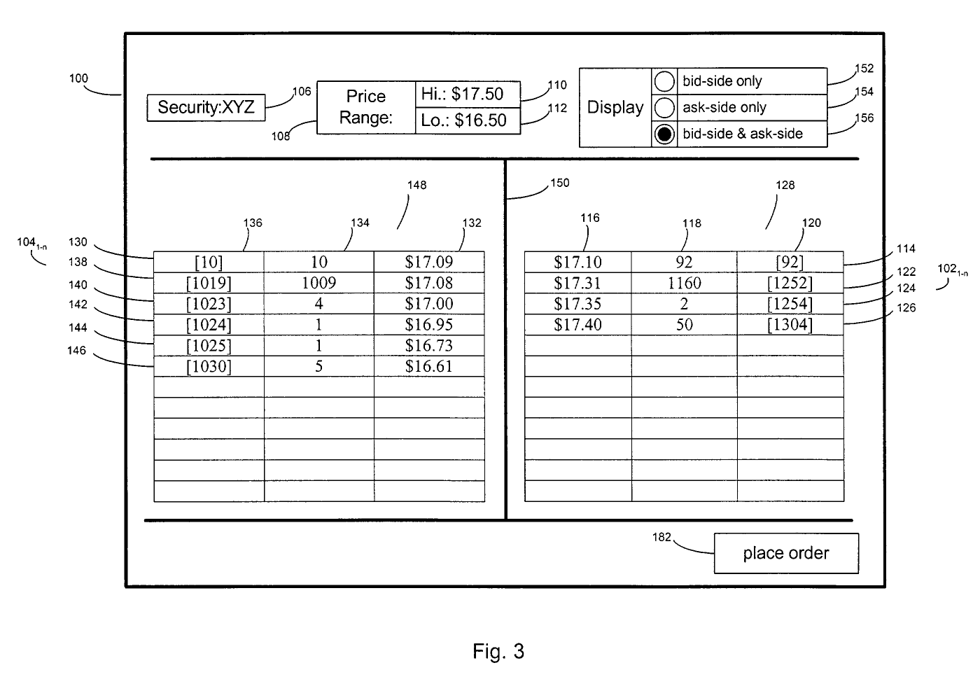

Referring to FIGS. 2 and 3, execution process 26 includes an aggregated display process 28 that displays one or more groups of shares 102₁₋ₙ, 104₁₋ₙ, of a specific security 106 that is traded on computerized trading system 16. A user selection process 30 allows market participant 20 to select one or more of these groups of shares. Once these groups of shares are selected, a user order entry process 32 generates an order concerning these selected groups of shares. While processing the order, order entry process 32 displays an order entry window 33 that includes information concerning the groups of shares selected, as well as processing parameters concerning the specific order being processed. Through the use of market participant profiling process 10 (FIG. 1), one or more of these processing parameters can be pre-defined and, therefore, automatically entered into order entry window 33. This will be discussed below in greater detail.

Summarized display 100 allows market participant 20 to monitor the trading activity for a particular security 106, such that the summarized display lists groups of shares 102₁₋ₙ, 104₁₋ₙ, that are either offered for sale or sought for purchase. Through summarized display 100, market participant 20 can select one or more of these groups of shares and execute an order, effectuating the purchase, sale, or purchase and sale of the selected groups of shares.

Aggregated display process 28 includes a security selection process 34 that allows market participant 20 to select the specific security 106 they wish to monitor. This selection may occur is several different ways and will vary depending on the manner in which process 34 is implemented and configured by administrator 36. For example, market participant 20 may select the security they wish to monitor via a drop-down menu (not shown) that allows the market participant to scroll through a list of securities to select the one they wish to monitor. This drop down menu may utilize ticker symbols or may list the full name of the issuer of the security. Alternatively, market participant 20 may wish to enter the security's ticker symbol directly, thus allowing for quicker selection.

Process 28 also includes a price range specification process 38 that allows market participant 20 to select a desired price range 108 for the specific security 106 they wish to monitor (i.e., the security market participant 20 selected with security selection process 34).

When securities are traded, outstanding offers to sell the security have a higher price associated with them then the outstanding bids to buy the same security. Once the price of the bid to buy is equal to the price of the offer to sell, a trade of the security occurs. For example, if Market Participant A wishes to sell one share of XYZ corp. for $10 but Market Participant B, who wants to purchase one share of XYZ corp., is only willing to pay $9 for it, a trade of this security will not occur until: (a) Market Participant A lowers their offer price to $9, (b) Market Participant B raises their bid price to $10, or (c) the two market participants meet somewhere in the middle. Further, as there are typically multiple sellers, these sellers tend to offer their shares at different prices. Additionally, as there are also multiple buyers, these buyers tend to wish to purchase shares at different prices. Therefore, concerning a specific security, there is typically a wide range of prices that span from the very low bid to buy, through the actual trading value, and right up to the very high offer to sell.

Price range specification process 38 allows market participant 20 to define a price range for the specific security 106 they wish to monitor. This price range selection may occur is several different ways and will vary depending on the manner in which process 38 is implemented and configured by administrator 36. For example, market participant 20 may select the price range of securities they wish to monitor via a drop-down menu that allows the market participant to scroll through a list of price ranges and select the range they wish to monitor. Alternatively, market participant 20 may be able to manually enter an upper limit 110 and a lower limit 112. Additionally, market participant 20 may be able to enter a specific price (e.g., $10). Therefore, for this example, the range would be a fixed dollar amount in which the upper limit 110 is equal to the lower limit 112. Further, market participant 20 may be able to enter a wildcard descriptor (e.g., *) for either or both limits. Therefore, the range could be from negative infinity to positive infinity, resulting in all shares of the selected security being displayed (regardless of their offer/bid price). The use of price range specification process 38 by market participant 20 results in summarized display 100 being filtered to remove any shares of the specific security 106 that fall outside of the desired price range 108 selected by market participant 20.

Once a security 106 is selected and a desired price range 108 is specified, a trade data interface process 40 retrieves, from storage device 27 of server 12, the relevant trade data concerning the security selected by market participant 20. Typically, summarized display 100 is a real-time display, in that the information shown within the display is regularly updated (at a frequency defined by administrator 36) so that it is always accurate and up to date. Accordingly, trade data interface process 40 typically establishes a connection (e.g., a socket) with computerized trading system 16 so that the information provided in display 100 is always relevant and up-to-date.

Once a connection is established by trade data interface process 40 and the relevant trade data is retrieved, summarized display 100 is populated. As stated above, summarized display 100 allows market participant 20 to quickly and easily discern the trading activity associated with the specific security 106 that market participant 20 wishes to monitor, and select and purchase various groups of shares of that security.

An ask-side aggregated display process 42 displays, in a multi-column format, ask-side entries 102₁₋ₙ for the security that was selected by market participant 20, and is currently being traded on computerized trading system 16 in the desired price range 108 selected by market participant 20. Each discrete ask-side entry 102₁₋ₙ represents a discrete group of the specific security 106 selected by market participant 20, such that these groups of securities are being offered for sale by another market participant (or group of market participants) at a common price that is within the desired price range 108 specified by market participant 20. For example, assume that market participant 20 used security selection process 34 to select XYZ corp. as the specific security 106 they wish to monitor. Further, assume that market participant 20 used price range specification process 38 to enter a desired price range 108 of $16.50 (lower limit 112) to $17.50 (upper limit 110). Summarized display 100 would then be populated with ask-side entries 102₁₋ₙ that met the criteria specified by market participant 20.

Ask-side entry 114 concerns a group of ninety-two shares of the security XYZ corp. that is currently being offered for sale. Ask-side entry 114 includes multiple columns, each of which provides information concerning the discrete group of securities being offered for sale, such as an ask price 116 (i.e., the price requested by the market participant (s) for one share of XYZ corp.), a lot size 118 (i.e., the quantity of shares of the selected security available at that ask price from those market participant(s)), and an aggregate value 120 (i.e., the total sum of shares available at the ask price or lower).

Ask-side aggregated display process 42 includes a tabular display process 44 for simultaneously displaying multiple ask-side entries (e.g., ask-side entries 114, 122, 124, 126). These ask-side entries are arranged vertically so that the ask price, lot size, and aggregate value of each entry are aligned, forming ask-side table 128.

Therefore, for this particular summarized display 100, if market participant 20 is willing to pay up to $17.10 for a share of XYZ corp., market participant 20 could buy up to ninety-two shares for that price. This is shown in ask-side entry 114. However, if market participant 20 desires a ninety-third share of XYZ corp., market participant 20 is going to have to pay $17.31 for that one additional share (see ask-side entry 122), since there are only ninety-two shares of XYZ corp. for sale at $17.10. If market participant 20 wants to purchase additional shares of XYZ corp., they can purchase up to eleven-hundred-sixty shares for $17.31 per share (see ask-side entry 122).

Ask-side entries 114, 122, 124, 126 do not necessarily represent the shares available for a certain price from a single market participant. Conversely, the individual ask-side entries may represent the combined total number of shares available of a specific security 102 for a specific asking price. Therefore, this combined total number of shares may be offered for sale by a single market participant or a group of market participants.

For example, assume that the total groups of shares of XYZ corp. offered for sale by the individual market participants trading on computerized trading system 16 are as follows:

| | Ask Price | Aggregate Value | Lot Size | Market Participant |
|---|---|---|---|---|
| Offer 1 | $17.10 | [92] | 92 | D |
| Offer 2 | $17.31 | [142] | 50 | M |
| Offer 3 | $17.31 | [253] | 111 | H |
| Offer 4 | $17.31 | [1252] | 999 | Y |
| Offer 5 | $17.35 | [1253] | 1 | Z |
| Offer 6 | $17.35 | [1254] | 1 | E |
| Offer 7 | $17.40 | [1304] | 50 | B |
| Offer 8 | $18.09 | [1305] | 1 | C |
| Offer 9 | $18.09 | [1309] | 4 | A |
| Offer 10 | $18.11 | [1310] | 1 | U |
| Offer 11 | $18.12 | [1311] | 1 | G |
| Offer 12 | $18.13 | [1312] | 1 | K |

Notice that there are three market participants (namely M, H, and Y) that are offering shares of XYZ corp. for $17.31 per share. The combined number of shares of XYZ corp. offered by these three market participants for $17.31 is [50+111+999] for a total of eleven-hundred-sixty shares. These three separate and distinct offers (i.e., Offer 2, Offer 3, and Offer 4) are represented by ask-side entry 122. Further, Offer 1 is represented by ask-side entry 114, Offer 5 and Offer 6 are represented by ask-side entry 124, and Offer 7 is represented by ask-side entry 126. Further, notice that Offers 8-12 are not represented in ask-side table 128, as they are greater than the upper limit 110 of desired price range 108.

Process 26 includes an ask-side aggregate calculation process 46 for calculating the ask-side aggregate value 116 for each ask-side entry. Ask-side aggregate calculation process 46 determines the ask-side aggregate value 120 for a particular ask-side entry by summing the value of the lot size for that particular ask-side entry with the lot sizes of all preceding ask-side entries included in ask-side table 128. For example, the aggregate value for ask-side entry 114 is [92], the aggregate value for ask-side entry 122 is [1252, i.e., 92+1160], the aggregate value for ask-side entry 124 is [1254, i.e., 92+1160+2], and so forth.

A tabular sorting process 48 sorts ask-side entries (e.g., 114, 122, 124, 126) in accordance with a user-defined sorting parameter, such as ascending or descending ask prices, ascending or descending lot sizes, for example. This enables market participant 20 to group and order the ask-side entries within ask-side table 128 in accordance with their personal preferences. However, the ask-side entries within ask-side table 128 are typically sorted by ask price (as shown in FIG. 3).

In a manner similar to ask-side aggregated display process 42, a bid-side aggregated display process 50 displays, in a multi-column format, bid-side entries 104₁₋ₙ for the same security (i.e., XYZ corp.) that was selected by market participant 20 and is currently being traded on computerized trading system 16 for a common price that is in the desired price range 108 selected by market participant 20. Each discrete bid-side entry 104₁₋ₙ represents a discrete group of the specific security 106 selected by market participant 20 that is sought for purchase by another market participant (or group of market participants) of computerized trading system 16. For example, bid-side entry 130 concerns a group of ten shares of the security XYZ corp. that a market participant or group of market participants currently wants to purchase for $17.09 per share. Similar to an ask-side entry, a bid-side entry includes multiple columns, each of which provides information concerning the discrete group of securities sought for purchase, such as a bid price 132 (i.e., the price that the market participant(s) would like to pay for one share of XYZ corp.), a lot size 134 (i.e., the quantity of shares of the selected security that the market participant(s) want to purchase at that bid price), and an aggregate value 136 (i.e., the total sum of shares sought for purchase at that bid price or higher).

Bid-side aggregated display process 50 includes a tabular display process 52 for simultaneously displaying multiple bid-side entries (e.g., bid-side entries 130, 138, 140, 142, 144, 146). These bid-side entries are arranged vertically so that the bid price, lot size, and aggregate value of each entry are aligned, forming an bid-side table 148.

Therefore, for this particular summarized display 100, if market participant 20 owns two-thousand shares of XYZ corp. that they are willing to sell for no less than $17.09 per share, market participant 20 can only sell ten shares, as bid-side entry 130 specifies that only ten shares of XYZ corp. are sought at $17.09 per share. However, if market participant 20 is willing to lower their sell price to $17.08 per share, they can sell one-thousand-nineteen shares of XYZ corp. at that price (i.e., $17.08) or better. Specifically, ten shares can be sold for $17.09 per share (see bid-side entry 130) and one-thousand-nine shares can be sold for $17.08 per share (see bid-side entry 138), for a total of one-thousand-nineteen shares.

Again, bid-side entries 130, 138, 140, 142, 144, 146 do not necessarily represent the shares sought for purchase by a single market participant at a certain price. Conversely, the individual bid-side entries represent the combined total number of shares sought for purchase at a certain price, regardless of the market participant(s) wishing to make the purchase. Therefore, this combined total number of shares may be sought by a single market participant or a group of market participants.

For example, assume that the total groups of shares of XYZ corp. sought for purchase by the individual market participants trading on computerized trading system 16 are as follows:

| | Bid Price | Aggregate Value | Lot Size | Market Participant |
|---|---|---|---|---|
| Bid 1 | $17.09 | [10] | 10 | A |
| Bid 2 | $17.08 | [20] | 10 | C |
| Bid 3 | $17.08 | [1019] | 999 | L |
| Bid 4 | $17.00 | [1020] | 1 | G |
| Bid 5 | $17.00 | [1021] | 1 | Z |
| Bid 6 | $17.00 | [1022] | 1 | M |
| Bid 7 | $17.00 | [1023] | 1 | R |
| Bid 8 | $16.95 | [1024] | 1 | A |
| Bid 9 | $16.73 | [1025] | 1 | L |
| Bid 10 | $16.61 | [1030] | 5 | Q |
| Bid 11 | $16.44 | [1031] | 1 | Z |
| Bid 12 | $16.11 | [1036] | 5 | P |

Notice that there are two market participants (namely C and L) that are bidding $17.08 per share for shares of XYZ corp. The combined number of shares of XYZ corp. sought by these two market participants at $17.08 per share is [10+999] for a total of one-thousand-nine shares. These two separate and distinct bids (i.e., Bid 2, and Bid 3) are represented by bid-side entry 138. Further, Bid 1 is represented by bid-side entry 130; Bid 4, Bid 5, Bid 6, and Bid 7 are represented by bid-side entry 140; Bid 8 is represented by bid-side entry 142; Bid 9 is represented by bid-side entry 144; and Bid 10 is represented by bid-side entry 146. Further, notice that Bids 11-12 are not represented in bid-side table 148, as they are less than the lower limit 112 of desired price range 108.

Process 26 includes a bid-side aggregate calculation process 54 for calculating the bid-side aggregate value 136 for each bid-side entry. As with ask-side aggregate calculation process 46, bid-side aggregate calculation process 54 determines the bid-side aggregate value 136 for a particular bid-side entry by summing the value of the lot size for that particular bid-side entry with the lot sizes of all preceding bid-side entries included in bid-side table 148. For example, the aggregate value for bid-side entry 130 is [10], the aggregate value for bid-side entry 138 is [1019, i.e., 10+1009], the aggregate value for bid-side entry 140 is [1023, i.e., 10+1009 so forth.

Similar to that of ask-side entries, a tabular sorting process 56 sorts bid-side entries (e.g., 130, 138, 140, 142, 144, 146) in accordance with a user-defined sorting parameter, such as ascending or descending bid prices, ascending or descending lot sizes, etc. This enables market participant 20 to group and order the bid-side entries within bid-side table 148 in accordance with their personal preferences. Again, like ask-side table 128, bid-side entries within bid-side table 148 are typically sorted by bid price (as shown in FIG. 3).

Bid-side aggregated display process 50 displays bid-side entries so that bid-side table 148 is essentially a mirror image of ask-side table 128. Specifically, the columns in bid-side table 148 are arranged in a fashion so that they are in the opposite order (i.e., when moving across the tables 128, 148 in a common direction) to that of ask-side table 128. The columns of these tables are essentially mirrored around an imaginary centerline 150. For example, column 116 and column 132 (i.e., ask prices and bid prices respectively) are the closest columns to centerline 150. Further, column 118 and column 134 (i.e., ask-side and bid-side lot sizes respectively) are the second closest columns to centerline 150. And finally, column 120 and column 136 (i.e., ask-side and bid-side aggregate values respectively) are furthest columns away from centerline 150.

Process 28 includes a display deactivation process 58 that allows market participant 20 to control the content of summarized display 100. Specifically, display deactivation process 58 allows market participant 20 to selectively deactivate either ask-side aggregated display process 42 or bid-side aggregated display process 50. Therefore, if market participant 20 is only interested in buying shares of XYZ corp., they can deactivate bid-side aggregated display process 50. Alternatively, if market participant 20 is only interested in selling shares of XYZ corp., they can deactivate ask-side aggregated display process 42. Typically, market participant 20 makes this selection (concerning what is to be deactivated) via summarized display 100. Summarized display 100 may include check boxes 152, 154, 156 that allow market participant 20 to display “bid-side only” (i.e., ask-side deactivated), “ask-side only” (i.e., bid side deactivated), or “bid-side & ask-side” (i.e., neither deactivated). Alternatively, a drop down menu (not shown) may be included to allow the market participant to select which (if any) process is deactivated.

As stated above, summarized display I 00 allows market participant 20 to quickly and easily discern the trading activity associated with the specific security 106 that market participant 20 wishes to monitor, and select and purchase various groups of shares of that security. Accordingly, securities order execution process 26 includes a market participant selection process 30 that allows market participant 20 to select one or more of the ask-side entries 102₁₋ₙ or bid-side entries 104₁₋ₙ they are interested in. This selection can occur in several different ways. For example, using a mouse or some other pointing device (not shown), the market participant can select (i.e., “click on”) the entries that they are interested in. Specifically, if market participant 20 selects ask-side entries, they would be interested in buying shares represented by that ask-side entry. If the market participant selects bid-side entries, they would be interested in selling shares to the market participants represented by that bid-side entry.

Once market participant 20 selects the entries they are interested in, an order may be executed based on that selection by user order entry process 32. In order to facilitate this order execution, summarized display 100 includes an order execution button 182 that allows market participant 20 to execute orders based on the selections made on summarized display 100. Therefore, if an ask-side entry is selected when the order is executed (i.e., order execution button 182 is clicked), a buy order is entered for the shares of the security 106 represented by that ask-side entry. Alternatively, if a bid-side entry is selected when the order is executed, a sell order would be entered for the shares of the security 106 represented by that bid-side entry.

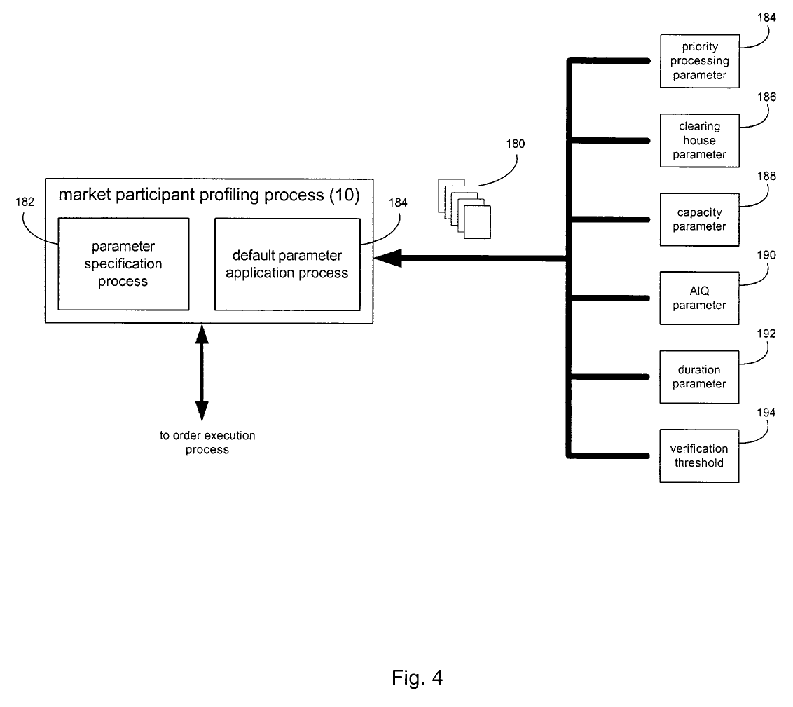

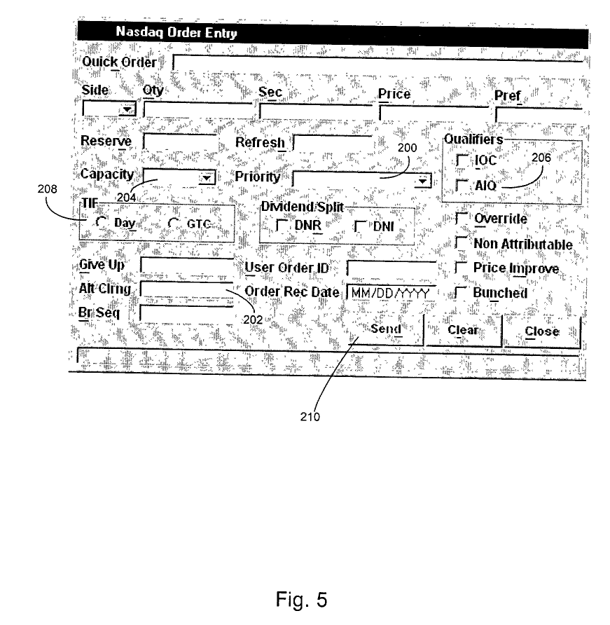

Referring to FIGS. 4 and 5, once order entry process 32 (FIG. 2) is initiated, market participant profiling process 10 automatically enters, into various fields within order entry window 33 (to be discussed below in greater detail), any default order processing parameters 180 that were previously defined by market participant 20.

Market participant profiling process 10 includes a parameter specification process 182 that allows market participant 20 to define these default order processing parameters 180, which include a priority processing parameter 184, a clearing house parameter 186, a capacity parameter 188, an AIQ parameter 190, a duration parameter 192, and a verification threshold 194.

Priority processing parameter 184 typically specifies one of three options concerning the sequence in which orders are processed by computerized trading system 16 (FIG. 1). These three options are “price/time”, “modified price/time”, and “price/size/time”. The “price/time” option specifies that the order entered is going to be processed in strict price/time priority. For example, when matching an outstanding offer-to-sell with an outstanding bid-to-buy, in the event that multiple bids-to-buy have a price matching one offer-to-sell, the time of order entry is used to determine which bid-to-buy is matched with the offer to sell, such that older bids-to-buy take preference over newer bids-to-buy. The “price/size/time” option functions similarly to the “price/time” option, with the difference being that whenever the share price is the same for multiple bids-to-buy or offers-to-sell, prior to looking at the time of order entry, the size of the order is examined, such that larger orders are given preference over smaller orders. The “modified price/time” also function similarly to the “price/time” option. The difference is that “modified price/time” takes into account access fees charged by certain market participant (e.g., Electronic Commerce Networks) when processing orders, in that the orders by market participants that do not charge access fees are processed prior to orders placed by those market participants that charge a fee.

Clearing house parameter 186 specifies one or more unique identifiers that identify the clearing house to be used to process the market participant's trades.

Capacity parameter 188 specifies the capacity in which the market participant is acting. Typical values for this parameter are agency or principle. A market participant acts as an agent if they enter an order for a third party, and they act as a principle if they enter an order for themselves.

AIQ (“Anti-Internalization Qualifier”) parameter 190 specifies whether the market participant is allowed to trade shares with themselves. Typically, a market participant is allowed to trade with themselves unless the AIQ parameter is enabled.

Duration parameter 192 specifies the amount of time that an order is valid. Typical values for this parameter are “TIF IOC”, “Day”, and “GTC”. “TIF IOC” specifies that the order must be immediately matched or else it is automatically withdrawn. “Day” specifies that the order does not need to be matched immediately. However, if the order is not matched by the end of the trading day, the order is automatically withdrawn. “GTC” specifies that the order will remain open until it is manually withdrawn or matched.

Verification threshold 194 specifies a threshold amount of shares, such that any order involving a greater number of shares than this amount requires a separate verification of the order (by the market participant) prior to the order being completely processed.

As stated above, once order entry process 32 (FIG. 2) is initiated, market participant profiling process 10 automatically enters, into various fields within order entry window 33, any default order processing parameters 180 that were previously defined by market participant 20. Accordingly, order entry window 33 includes a field 200 for the priority processing parameter 184, a field 202 for the clearing house parameter 186, a field 204 for the capacity parameter 188, a field 206 for the AIQ parameter 190, and a field 208 for the duration parameter 192.

Market participant profiling process 10 includes a default parameter application process 184 for apply the default order processing parameters 180 that were specified by market participant 20 using parameter specification process 182. Provided that market participant 20 specified default values for priority processing parameter 184, clearing house parameter 186, capacity parameter 188, ATQ parameter 190, and duration parameter 192, the corresponding fields (i.e., fields 200, 202, 204, 206, 208, respectively) are automatically populated by default parameter application process 184 when order entry window 33 is generated. Further, if market participant 20 wishes to change any of the individual default order processing parameters 180 for a specific order, default parameter application process 184 allows market participant 20 to overwrite any of the default values with respect to that individual order. This overwriting may be accomplished by editing the default values automatically entered into order entry window 33. Additionally, parameter specification process 182 is configured so that market participant 20 may change or delete the default values that they previously assigned to the default order processing parameters 180.

In the event that market participant 20 entered a verification threshold 194, and the market participant 20 also entered an order for a quantity of shares that exceeds that verification threshold, market participant 20 will be required to confirm/verify the order prior to it being processed. Accordingly, user order entry process 32 (FIG. 2) may also include an order confirmation process 62 (FIG. 2) to perform this confirmation/verification process. This confirmation/verification would require market participant 20 to take some affirmative step to verify their intent to place the order. This can occur when market participant 20 clicks on an order confirmation button that appears as a separate pop-up window (not shown) once order execution button 210 (i.e., the “send” button) is clicked.

Once the order is executed and confirmed (if necessary), securities order execution process 26 (FIG. 2) provides computerized trading system 16 (FIG. 1) with the information required to effectuate the trade (e.g., security symbol, seller name, buyer name, sell price, buy price, quantity, etc.).

While the lot sizes 118, 134 described above are stated as being in units of shares, it is possible for these numbers to also represent groups of one-hundred shares (commonly referred to as “round lots”), or any other amount of shares. In this scenario, ask-side entry 114 may represent an offer to sell ninety-two-hundred shares of XYZ corp.

While imaginary centerline 150 is shown as being a vertical centerline, this is not meant to imply that the ask-side and bid-side entries must be mirrored around a vertical (or any other angle) axis. For example, imaginary centerline 150 may be a horizontal centerline, such that ask-side and bid-side entries are arranged in multi-row format and, therefore, mirroring occurs about a horizontal axis.

Further, while bid-side aggregated display process 50 is described above as being configured to display the bid-side entries so that the bid-side table is essentially a mirror image of the ask-side table, it is possible for the same result to be achieved in a different manner. Specifically, the ask-side aggregated display process 42 may be configured to display the ask-side entries so that the ask-side table is essentially a mirror image of the bid-side table. This would achieve the same end result.

Additionally, while the default order processing parameters 180 are described as including a priority processing parameter 184, a clearing house parameter 186, a capacity parameter 188, an AIQ parameter 190, a duration parameter 192, and a verification threshold 194, these are only intended to be illustrative examples and are not intended to be an all-inclusive list.

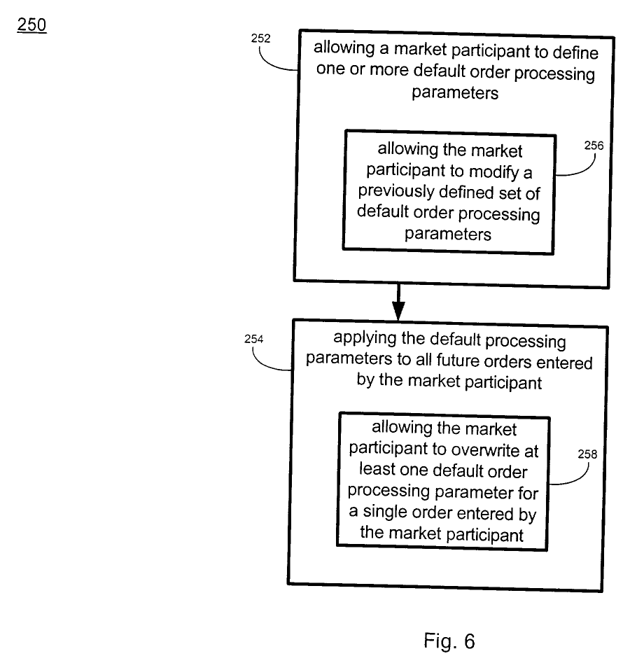

Referring to FIG. 6, there is shown a market participant profiling method 250 that includes allowing 252 a market participant to define one or more default order processing parameters, and applying 254 the default order processing parameters to all future orders entered by the market participant.

Allowing 252 a market participant may include allowing 256 the market participant to modify a previously defined set of default order processing parameters. Further, applying 254 the default order processing parameters may include allowing 258 the market participant to overwrite at least one default order processing parameter for a single order entered by the market participant.

The system described herein is not limited to the hardware embodiment described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers that each includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system may also be implemented as a machine-readable storage medium, configured with a computer program, where, upon execution, instructions in the computer program cause a machine to operate to perform the functions of the system described above.

Embodiments of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Embodiments of the system may also be implemented using integrated circuit blocks referred to as main memory, cache memory, or other types of memory that store electronic instructions to be executed by a microprocessor or store data that may be used in arithmetic operations.

A number of embodiments of the invention have been described. Nevertheless, it will be understood that various modifications may be made without departing from the spirit and scope of the invention.

What is claimed is:

1. A market participant profiling process comprising:
a parameter specification process for allowing a market participant to define one or more default order processing parameters; and
a default parameter application process for applying the default order processing parameters to all future orders entered by the market participant.

2. The market participant profiling process of claim 1 wherein the parameter specification process is configured to allow the market participant to modify a previously defined set of default order processing parameters.

3. The market participant profiling process of claim 1 wherein the default order processing parameter is a priority processing parameter that specifies the sequence in which incoming orders entered by the market participant are processed.

4. The market participant profiling process of claim 1 wherein the default order processing parameter is a clearing house parameter that specifies the clearing house that will process the order entered by the market participant.

5. The market participant profiling process of claim 1 wherein the default order processing parameter is a capacity parameter that specifies the capacity in which the market participant who placed the order is acting.

6. The market participant profiling process of claim 1 wherein the default order processing parameter is an AIQ parameter that prevents the market participant who entered the order from trading with itself.

7. The market participant profiling process of claim 1 wherein the default order processing parameter is a duration parameter that specifies the duration of the order entered by the market participant.

8. The market participant profiling process of claim 1 wherein the default order processing parameter is a verification threshold, and orders involving a greater number of shares than the verification threshold require verification of the order by the market participant prior to the order being processed.

9. The market participant profiling process of claim 1 wherein the default parameter application process is configured to allow the market participant to overwrite at least one default order processing parameter for a single order entered by the market participant.

10. A market participant profiling method comprising:
allowing a market participant to define one or more default order processing parameters; and
applying the default order processing parameters to all future orders entered by the market participant.

11. The market participant profiling method of claim 10 wherein allowing a market participant to define includes allowing the market participant to modify a previously defined set of default order processing parameters.

12. The market participant profiling method of claim 10 wherein the default order processing parameter is a priority processing parameter that specifies the sequence in which incoming orders entered by the market participant are processed.

13. The market participant profiling method of claim 10 wherein the default order processing parameter is a clearing house parameter that specifies the clearing house that will process the order entered by the market participant.

14. The market participant profiling method of claim 10 wherein the default order processing parameter is a capacity parameter that specifies the capacity in which the market participant who placed the order is acting.

15. The market participant profiling method of claim 10 wherein the default order processing parameter is an AIQ parameter that prevents the market participant who entered the order from trading with itself.

16. The market participant profiling method of claim 10 wherein the default order processing parameter is a duration parameter that specifies the duration of the order entered by the market participant.

17. The market participant profiling method of claim 10 wherein the default order processing parameter is a verification threshold, and orders involving a greater number of shares than the verification threshold require verification of the order by the market participant prior to the order being processed.

18. The market participant profiling method of claim 10 wherein applying the default order processing parameters includes allowing the market participant to overwrite at least one default order processing parameter for a single order entered by the market participant.

19. A computer program product residing on a computer readable medium having a plurality of instructions stored thereon which, when executed by the processor, cause that processor to:
allow a market participant to define one or more default order processing parameters; and
apply the default order processing parameters to all future orders entered by the market participant.

20. The computer program product of claim 19 wherein instructions to allow a market participant to define further includes instructions to allow the market participant to modify a previously defined set of default order processing parameters.

21. The computer program product of claim 19 wherein the default order processing parameter is a priority processing parameter that specifies the sequence in which incoming orders entered by the market participant are processed.

22. The computer program product of claim 19 wherein the default order processing parameter is a clearing house parameter that specifies the clearing house that will process the order entered by the market participant.

23. The computer program product of claim 19 wherein the default order processing parameter is a capacity parameter that specifies the capacity in which the market participant who placed the order is acting.

24. The computer program product of claim 19 wherein the default order processing parameter is an AIQ parameter that prevents the market participant who entered the order from trading with itself.

25. The computer program product of claim 19 wherein the default order processing parameter is a duration parameter that specifies the duration of the order entered by the market participant.

26. The computer program product of claim 19 wherein the default order processing parameter is a verification threshold, and orders involving a greater number of shares than the verification threshold require verification of the order by the market participant prior to the order being processed.

27. The computer program product of claim 19 wherein instructions to apply the default order processing parameters further includes instructions to allow the market participant to overwrite at least one default order processing parameter for a single order entered by the market participant.
